(19) United States
(12) Patent Application Publication
(10) Pub. No.: US 2021/0388471 A1
(43) Pub. Date: Dec. 16, 2021

(54) ALUMINUM ALLOY, WIRE AND CONNECTING ELEMENT MADE OF THE ALUMINUM ALLOY

(71) Applicants: DRAHTWERK ELISENTAL W. ERDMANN GMBH & CO., Neuenrade (DE); RICHARD BERGNER VERBINDUNGSTECHNIK GMBH & CO. KG, Schwabach (DE)

(72) Inventors: THEODOR WINGEN, NEUENRADE (DE); JANINA DRUSKUS, LUEDENSCHEID (DE); KATHARINA NEUERER, SCHWABACH (DE); RALF JENNING, WINDSBACH (DE); CULHA BUESRA, SCHWARZENBRUCK (DE); KLAUS MAUEROEDER, SCHWABACH (DE)

(21) Appl. No.: 17/458,888

(22) Filed: Aug. 27, 2021

Related U.S. Application Data
(63) Continuation-in-part of application No. 16/296,314, filed on Mar. 8, 2019.
Application No. 16/296,314 is a continuation of application No. PCT/EP2018/053904, filed on Feb. 16, 2018.

(30) Foreign Application Priority Data
Feb. 17, 2017 (EP) 17156731.6

(51) Int. Cl. C22C 21/18; C22C 21/16; C22C 21/14; F16B 35/00

(52) U.S. Cl. CPC C22C 21/18; F16B 35/00; C22C 21/14; C22C 21/16

(57) ABSTRACT

An aluminum alloy for manufacturing wire for cold forming, in particular for manufacturing connecting elements, includes an alloy content of aluminum greater than 88 mass % and an alloy content of copper greater than or equal to 5 mass % as main alloy elements. The aluminum alloy contains no boron. Nickel and silicon are additional alloy elements, with an alloy content of nickel greater than or equal to 0.15 mass %, and an alloy content of silicon less than or equal to 1.0 mass %. A wire for manufacturing connecting elements or screws and a connecting element or screw made of the aluminum alloy are also provided.

### CROSS-REFERENCE TO RELATED APPLICATION

This application is a continuation-in-part of U.S. application Ser. No. 16/296,314, filed Mar. 8, 2019, which was a continuation application, under 35 U.S.C. § 120, of International Application PCT/EP2018/053904, filed Feb. 16, 2018, which designated the United States; this application also claims the priority, under 35 U.S.C. § 119, of European Patent Application EP 17 156 731.6, filed Feb. 17, 2017; the prior applications are herewith incorporated by reference in their entirety.

### BACKGROUND OF THE INVENTION

### Field of the Invention

The invention relates to an aluminum alloy for manufacturing wire for cold forming, in particular for manufacturing connecting elements, having an aluminum content greater than 88% and a copper content greater than or equal to 5% as main alloy elements. The invention further relates to a wire manufactured from the aluminum alloy as well as to a connecting element manufactured from the aluminum alloy.

In the automotive sector, reducing the weight of components is of great importance, because the weight of an automobile directly influences fuel consumption and CO₂ emissions. One area of focus in that case is using light metals such as aluminum and magnesium. Aluminum screws are used as connecting elements for components that have been manufactured from those metals, in particular for connecting housing components. The advantage of using connecting elements of the same kind lies not only in the weight savings compared to steel screws, but also in the lower corrosion potential and the epitaxial extension of the connecting element and component during operation. Aluminum alloys and their chemical composition are listed in the German Institute of Standardization DIN EN 573-3.

As a compromise between formability, strength and corrosion resistance, an aluminum alloy according to EN AW-6056 (Al Si1MgCuMn) is used for manufacturing aluminum screws. The drawback of that aluminum alloy, however, is that it has only limited temperature resistance. Therefore, connecting elements made of that alloy may only be used in temperature ranges up to 150° C., for example for screwing in the oil pan or the gear housing. Connecting elements manufactured from that alloy are not suitable for areas where higher temperatures occur, particularly in the motor area, where there are temperatures of 180° C. and higher. In addition, the mechanical characteristics of those alloys are inadequate for many applications in the automotive sector. For that reason, steel screws are still used for screwing in the cylinder head, for example, although the engine block is commonly manufactured from light metal.

In the aerospace industry, connecting elements are used which are manufactured from an aluminum alloy according to EN AW-2024 (Al Cu4Mg1). Those are high-strength alloys which, by precipitating the Al2Cu phases through effective precipitation hardening, enable tensile strengths of up to Rₘ=570 MPa. Manufacturing wire from that alloy, however, is very costly.

Boron is often added in alloys for grain refinement. Such grain refinement results in a finer microstructure. However, such a finer microstructure promotes “creep.” In materials, creep (also known as retardation) refers to viscoelastic or plastic deformation that is dependent on time and temperature Therefore, an addition of boron reduces strength and heat-resistance in components such as aluminum screws.

However, it is not possible for boron to be unintentional (as a contamination) in an aluminum alloy. The reason is that the basic materials from which the aluminum alloy components are obtained, e.g. bauxite for aluminum or other rock types or ore types (for the different alloy components being used) do not contain boron.

### SUMMARY OF THE INVENTION

It is accordingly an object of the invention to provide an aluminum alloy, a wire and a connecting element made of the aluminum alloy, which overcome the hereinafore-mentioned disadvantages of the heretofore-known products of this general type and in which the aluminum alloy has high strength and corrosion resistance, enables cost-effective wire production, and is suitable for manufacturing connecting elements for use in temperature ranges of 180° C. and higher.

With the foregoing and other objects in view there is provided, in accordance with the invention, an aluminum alloy for manufacturing wire for cold forming, in particular for manufacturing connecting elements, having an aluminum content greater than 88% and a copper content greater than or equal to 5% as the main alloy elements. The aluminum alloy contains no boron. In addition to an aluminum content greater than 88% and a copper content greater than or equal to 5%, nickel and silicon are additional alloy elements, with the nickel content of the alloy being greater than or equal to 0.15% and the silicon content being less than or equal to 1.0%, with the silicon content nonetheless being significant and at least 0.1%. All of the aforementioned and subsequent content portions are stated in mass %. The aluminum content in this case is preferably greater than 89% or greater than 90%. For example, it is either in the 88% to 90% range or is greater than 90%.

The aluminum alloy does not contain boron, which eliminates the creep described above. The presence of boron would clearly run counter to the object of the present application, which is to produce a “high-strength” and heat-resistant aluminum alloy, wire and connecting element, such as a screw.

Surprisingly, adding these proportions of nickel and silicon has proven to provide high strength and also an improved processability.

This effect is accomplished in particular when the nickel content of the alloy is between 0.15% and 1.0% and/or the silicon content of the alloy is between 0.4% and 1.0%. The preferred copper content of the alloy is between 5.0% and 6.1%.

In a refinement of the invention, magnesium is an additional alloy component, and the magnesium content of the alloy is between 1.5% and 2.2%. This imparts a superior basic strength to the alloy, which enables highly superior strength properties of the alloy when nickel is added as an additional alloy component.

In an additional configuration of the invention, manganese and/or titanium are additional alloy components. Manganese has a positive effect on the heat resistance of the alloy, while titanium has a grain-refining effect, which improves formability.

With the objects of the invention in view, there is also provided a wire manufactured from such an alloy.

With the objects of the invention in view, there is furthermore provided a connecting element manufactured from such an alloy.

Additional refinements and configurations of the invention are set forth in the dependent claims. An exemplary embodiment is described in detail below:

One alloy that has been selected as a preferred exemplary embodiment includes the following composition:

| Alloy elements | Mass % |
|---|---|
| Silicon (Si) | 0.65 |
| Iron (Fe) | 0.09 |
| Copper (Cu) | 5.72 |
| Manganese (Mn) | 0.48 |
| Magnesium (Mg) | 1.82 |
| Chromium (Cr) | 0.11 |
| Nickel (Ni) | 0.8 |
| Zinc (Zn) | 0.18 |
| Titanium (Ti) | 0.15 |

Furthermore, other admixtures may be present that do not exceed 0.15% in total and preferably do not exceed 0.05% individually. (As an alternative to the listed Mg and Zn values, these values may also deviate slightly, for example 1.83% (Mg) and 0.19% (Zn).)

A wire rod based on an alloy according to this exemplary embodiment enables an economical wire drawing process because the wire is drawn to the desired final diameter. This wire, in turn, makes it possible to cost-effectively manufacture connecting elements, particularly screws. They are manufactured by processes that are known in the art. Specifically, a head with a shank is formed from the wire by one or more (cold-)forming processes, and at least a portion of the shank is provided with a thread, in particular by thread rolling. Alternatively, a threaded bolt may be manufactured, or other connecting or fastening elements such as rivets.

Due to the improved properties of the alloy, cold-formed connecting elements manufactured from this wire, in particular screws, combine high mechanical and corrosion stability with high heat resistance. Due to their temperature resistance, such connecting elements may also be used in temperature ranges of 180° C. and higher.

Specifically, connecting elements manufactured from this aluminum alloy, particularly screws, have a tensile strength of preferably more than 570 MPa (at room temperature). Compared to the typical aluminum alloy according to EN AW-6056, this alloy shows a significantly improved tensile strength.

In a preferred refinement, the connecting element manufactured from this alloy, in particular a screw, is distinguished by a particularly high heat resistance. Thus, under a temperature load of 200° C. over 24 hours, the connecting element still shows a remaining tensile strength that is greater than 0.8 times the tensile strength at room temperature. In addition or alternatively, the remaining tensile strength is more than 400 MPa and in particular more than 450 MPa. Furthermore, it is apparent that the tensile strength overall has only an approximately linear decrease with a low gradient. The tensile strength remains at a high level of approximately 500 MPa.

In consequence, such a connecting element is particularly suited for use in thermally highly stressed areas, and is expediently used in such thermally highly stressed areas. “Thermally highly stressed areas” are areas that at least intermittently have a temperature of greater than 150° C., preferably greater than 180° C. and preferably greater than 200° C. These temperatures are reached for example recurrently for periods of more than 0.5 hours or more than 1-3 hours. Such thermally recurring stresses occur, for example, in vehicle engines.

Specifically, the connecting element is used and installed inside a motor vehicle, particularly in the engine area and especially in the engine itself. The engine is in particular an internal combustion engine. The screw is therefore used in particular as a engine screw, for example as a cylinder head screw.

Alternatively, the connecting element is preferably used as an electrical contact element, especially in the area of a battery connection of a motor vehicle battery. The connecting element is, for example, a pole terminal or a screw for such a pole terminal. Especially in electric vehicles with an electric drive motor, high-capacity accumulator batteries are installed in the vehicle that are charged at very high charging currents for short charging times. These accumulators are also constructed for a high-power output to the electric drive motors, which often have an electrical output of more than 100 KW. Due to the accordingly high currents, the electrical cables and especially the battery poles are subject to high thermal stress.

When a reference is made herein to the wire or connecting element being manufactured from an aluminum alloy, this refers to a wire or connecting element that is formed entirely of the alloy and optionally also has a coating, for example a lubricant coating. In addition, this also includes elements in which the wire or connecting element is formed of two different materials with a core of a first material and a jacket of a second material. Either the core (preferably) or the jacket is formed of the aluminum alloy according to the invention. Such a screw is presented in German Patent Application DE 10 2014 220 337 A1. In that screw, an aluminum core is surrounded by a titanium jacket. German Patent Application DE 10 2014 220 338 A1 provides a special manufacturing process for a screw of this kind.

There are numerous possibilities for configuring and refining the aluminum alloy according to the invention. On this point, reference is made, among others, to the dependent aluminum alloy claims, and to alloy compositions having the range given in Table 1 below:

| Alloy elements | Lower limit (in mass %) | Upper limit (in mass %) |
|---|---|---|
| Silicon (Si) | 0.4 | 1.0 |
| Iron (Fe) | 0 | 0.2 |
| Copper (Cu) | 5.0 | 6.1 |
| Manganese (Mn) | 0 | 0.5 |
| Magnesium (Mg) | 1.5 | 2.2 |
| Chromium (Cr) | 0 | 0.2 |
| Nickel (Ni) | 0.15 | 1.0 |
| Zinc (Zn) | 0 | 0.3 |
| Titanium (Ti) | 0 | 0.25 |

Other admixtures may not exceed 0.15% overall, and preferably 0.05% individually. The remainder is aluminum. The proportion of aluminum is greater than 88% and preferably greater than 90%. The proportion of aluminum is however preferably less than 93%.

Only inevitable admixtures may be included, which excludes boron.

Other features which are considered as characteristic for the invention are set forth in the appended claims.

Although the invention is illustrated and described herein as embodied in an aluminum alloy, a wire and a connecting element made of the aluminum alloy, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a simplified comparison diagram comparing the heat resistance of different aluminum alloys; and

FIG. 2 is a diagrammatic, partly broken-away, side-elevational view of a screw.

### DETAILED DESCRIPTION OF THE INVENTION

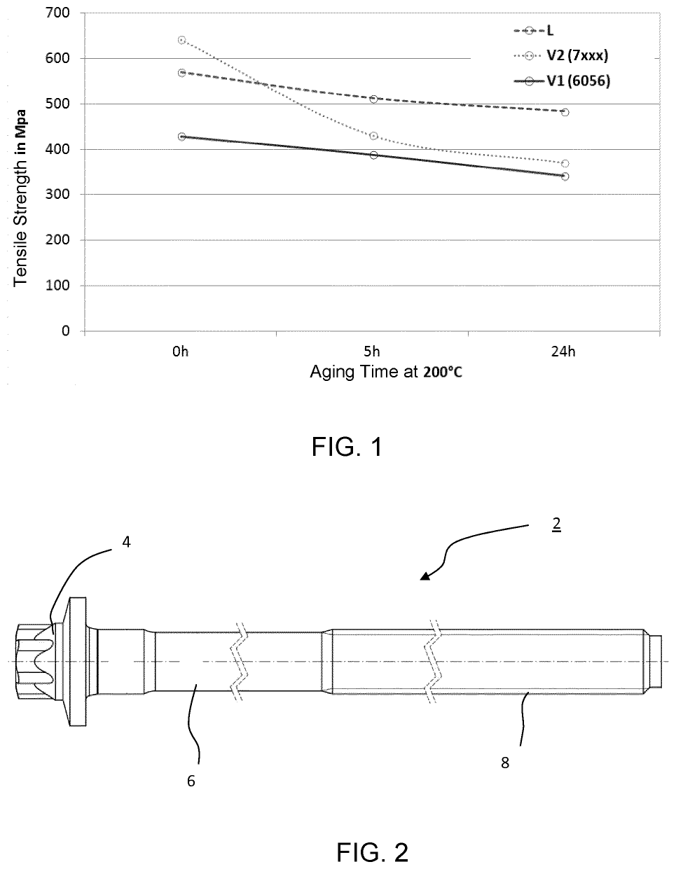

Referring now to the figures of the drawings in detail and first, particularly, to FIG. 1 thereof, there is seen a diagram which shows the tensile strength (given in MPa) over time (aging time) for elements (screws) made of different alloys. The elements were heated to 200° C. and kept at this temperature for a total of 24 hours.

The different alloys are two comparison alloys V1, V2 and an alloy L according to the invention (dashed line). Comparison alloy V1 is the alloy according to EN AW-6056 (solid line) and comparison alloy V2 is a 7xxx alloy (dotted line).

It is clear from the diagram that the alloy L according to the invention has a significantly higher tensile strength than the comparison alloy V1. Over the entire aging time, the tensile strength is more than 100 MPa above the tensile strength of the comparison alloy V1.

As compared to the comparison alloy V2, the alloy L according to the invention has a lower tensile strength at the start of the aging period, but is distinguished by a notably better heat resistance, so that the tensile strength remains high even at longer aging times. In addition, even after just a few hours, it has a higher tensile strength than the comparison alloy V2.

Due to these properties, the alloy L according to the invention is particularly suitable for, and indeed is used in, applications in fields with high thermal stress. In particular, the alloy is used for manufacturing connecting elements such as screws.

FIG. 2 shows an exemplary side view of such a screw 2. The screw 2 extends along a central longitudinal axis, starting from a head 4 to which a shank 6 is attached. One portion of the shank 6 is provided with a thread 8. The screw 2 shown in the drawing is an engine screw, specifically a cylinder head screw. These screws typically have a length ranging from several centimeters up to 10 or 15 cm and are constructed for example as M8, M10, M11 or M12 screws.

1. An aluminum alloy for manufacturing wire for cold forming or for manufacturing connecting elements, the aluminum alloy comprising:
an aluminum alloy having an aluminum content of greater than 88 mass % and a copper content of greater than or equal to 5 mass % as main alloy elements;
said aluminum alloy containing no boron;
an additional nickel alloy having a nickel content of greater than or equal to 0.15 mass %; and
an additional silicon alloy having a silicon content of less than or equal to 1.0 mass %.

2. The aluminum alloy according to claim 1, wherein said aluminum content of said aluminum alloy is between 88 mass % and 90 mass % or greater than 90 mass %.

3. The aluminum alloy according to claim 1, wherein said nickel content is between 0.15 mass % and 1.0 mass %.

4. The aluminum alloy according to claim 1, wherein said silicon content is between 0.4 mass % and 1.0 mass %.

5. The aluminum alloy according to claim 1, wherein said copper content is between 5.0 mass % and 6.1 mass %.

6. The aluminum alloy according to claim 1, which further comprises an additional magnesium alloy content of between 1.5 mass % and 2.2 mass %.

7. The aluminum alloy according to claim 1, which further comprises an additional alloy content of at least one of manganese or titanium.

8. The aluminum alloy according to claim 1, which further comprises:

| | | |
|---|---|---|
| 5.0 to 6.1 | mass % | Copper |
| 0.15 to 1.0 | mass % | Nickel, |
| 0.4 to 1.0 | mass % | Silicon |
| 0 to 0.2 | mass % | Iron |
| 0 to 0.2 | mass % | Manganese, |
| 1.5 to 2.2 | mass % | Magnesium, |
| 0 to 0.2 | mass % | Chromium |
| 0 to 0.3 | mass % | Zinc |
| 0 to 0.25 | mass % | Titanium, |
| 0 to 0.15 | mass % | admixtures and |
| | |
|---|---|
| a remainder | aluminum. |

9. A wire for manufacturing connecting elements or screws, the wire comprising the aluminum alloy according to claim 1.

10. A connecting element or screw, comprising the aluminum alloy according to claim 1.

11. The connecting element according to claim 10, wherein the connecting element has a tensile strength greater than 570 MPa at room temperature.

12. The connecting element according to claim 10, which further comprises a heat resistance provided by at least one of:
a remaining tensile strength of greater than 0.8 times a tensile strength at room temperature, or
a remaining tensile strength of greater than 400 MPa after undergoing a temperature load of 200° C. for 24 hours.

13. The connecting element according claim 12, wherein the remaining tensile strength is greater than 450 MPa after undergoing a temperature load of 200° C. for 24 hours.

14. The connecting element according to claim 11, which further comprises a heat resistance provided by at least one of:
a remaining tensile strength of greater than 0.8 times said tensile strength at room temperature, or
a remaining tensile strength of greater than 400 MPa after undergoing a temperature load of 200° C. for 24 hours.

15. The connecting element according claim 14, wherein the remaining tensile strength is greater than 450 MPa after undergoing a temperature load of 200° C. for 24 hours.

16. The connecting element according claim 10, which further comprises a heat resistance to a temperature at least intermittently above 180° C. in a thermally stressed area or in a motor vehicle.

17. The connecting element according to claim 10, wherein the screw is an engine screw of an internal combustion engine.

18. The connecting element according to claim 10, wherein the connecting element or screw is a contact element or a pole terminal or a screw for a pole terminal of an accumulator.
